(19) United States
(12) Patent Application Publication
(10) Pub. No.: US 2018/0224696 A1
(43) Pub. Date: Aug. 9, 2018

(54) BACKLIGHT MODULE, LIGHT GUIDE PANEL ASSEMBLY AND MANUFACTURING METHOD THEREFOR

(71) Applicants: BOE Technology Group Co., Ltd., Beijing (CN); Beijing BOE Display Technology Co., Ltd., Beijing (CN)

(72) Inventors: Haijun Shi, Beijing (CN); Ming Chen, Beijing (CN); Zhanchang Bu, Beijing (CN); Xian Yang, Beijing (CN); Xianghua Jin, Beijing (CN); Wenxin Zhang, Beijing (CN)

(21) Appl. No.: 15/704,144

(22) Filed: Sep. 14, 2017

(30) Foreign Application Priority Data
Feb. 4, 2017 (CN) 201710064289.7

(51) Int. Cl. G02F 1/1335; F21V 8/00

(52) U.S. Cl. CPC G02F 1/133602; G02B 6/0031; G02B 6/0076

(57) ABSTRACT

A backlight module, a light guide panel assembly and a manufacturing method therefor are disclosed. The light guide panel assembly includes: two light guide panels; and bubble glue disposed between opposing surfaces of the two light guide panels and configured to adhere the two light guide panels together.

### CROSS-REFERENCE TO RELATED APPLICATION

This application claims benefit of Chinese Patent Application No. 201610064289.7 filed on Feb. 4, 2017, entitled “BACKLIGHT MODULE, LIGHT GUIDE PANEL ASSEMBLY AND MANUFACTURING METHOD THEREFOR” in the State Intellectual Property Office of China, the disclosure of which is incorporated in entirety herein by reference.

### BACKGROUND

### Technical Field

Embodiments of the present disclosure relate to a field of light guide panel, and more particularly, to a backlight module, a light guide panel assembly, a manufacturing method for the light guide panel assembly.

### Description of the Related Art

A light guide panel (Light Guide Panel, abbreviated as LGP) is usually used in a Liquid Crystal Display (referred to as LCD) device. LCD is not a self-luminous product, thus in order to show brightness for LCD, a backlight module is generally needed to implement photometric display. Further, the light guide panel is an important component of the backlight module. The main function of the light guide panel is to guide light rays to a direction which is desired by a designer, thereby making luminous and uniformity of the backlight module keep in line with the needs of LCD-side customers.

With the development of science and technology of display, the liquid crystal display is more and more widely used. In particular, a liquid crystal display having a double-sided display function can be applied to portable consumer electronic devices or can be used as a large-sized liquid crystal display television for public viewing.

### SUMMARY

Embodiments of the present disclosure provide a light guide panel assembly, a backlight module, and a manufacturing method for a light guide panel assembly.

According to an aspect of the present disclosure, there is provided a light guide panel assembly, comprising:

two light guide panels; and

bubble glue disposed between opposing surfaces of the two light guide panels and configured to adhere the two light guide panels together.

In an example, the bubble glue is fully charged between the opposing surfaces of the two light guide panels.

In an example, the bubble glue is applied to edges of the opposing surfaces of the two light guide panels so as to adhere the two light guide panels together.

In an example, air is charged in a space between the opposing surfaces of the two light guide panels other than the edges applied with the bubble glue.

In an example, the light guide panel assembly further includes a reflective sheet located between the opposing surfaces of the two light guide panels, the reflective sheet being parallel to the opposing surfaces of the two light guide panels and fixed by means of the bubble glue.

In an example, the bubble glue is glue containing high density bubbles.

In an example, the bubble glue is glue with low refractive index.

According to another aspect of the present disclosure, there is provided a backlight module, comprising the light guide panel assembly according to the above embodiments.

According to still another aspect of the present disclosure, there is provided a manufacturing method for a light guide panel assembly, comprising:

producing bubble glue of semi-solid state by stirring glue in an atmosphere of air; and

applying the bubble glue between opposing surfaces of two light guide panels so as to adhere the two light guide panels together.

In an example, the step of applying the bubble glue between the opposing surfaces of the two light guide panels comprises:

applying the bubble glue to edges of the opposing surfaces of the two light guide panels and filing air in a space between the opposing surfaces of the two light guide panels other than the edges applied with the bubble glue.

In an example, the step of applying the bubble glue between the opposing surfaces of the two light guide panels comprises:

charging the bubble glue between the opposing surfaces of the two light guide panels fully.

In an example, after applying the bubble glue, the method further includes:

providing a reflective sheet between the opposing surfaces of the two light guide panels.

In an example, the step of adhering the two light guide panels together comprises:

respectively adhering two sides of the reflective sheet with the bubble glue applied to the two light guide panels and making the reflective sheet parallel to the opposing surfaces of the two light guide panels.

### BRIEF DESCRIPTION OF THE DRAWINGS

FIG. 1 is a schematic structural view of a light guide panel assembly according to an embodiment of the present disclosure;

FIG. 2a is a schematic structural view of a light guide panel assembly according to an embodiment of the present disclosure; FIG. 2b is a flow chart of a manufacturing method for a light guide panel assembly shown in FIG. 2a;

FIG. 3a is a schematic structural view of a light guide panel assembly according to an embodiment of the present disclosure;

FIG. 3b is a flow chart of a manufacturing method for a light guide panel assembly shown in FIG. 3a;

FIG. 4a is a schematic structural view of a light guide panel assembly according to an embodiment of the present disclosure;

FIG. 4b is a schematic view showing bubble glue which is applied to edges of a light guide panel shown in FIG. 4a;

FIG. 4c is a flow chart of a manufacturing method for a light guide panel assembly shown in FIG. 4a;

FIG. 5a is a schematic structural view of a light guide panel assembly according to an embodiment of the present disclosure; and

FIG. 5b is a flow chart of a manufacturing method for a light guide panel assembly shown in FIG. 5a.

### DETAILED DESCRIPTION OF PREFERRED EMBODIMENTS

In order to provide a more clear understanding of the objectives, technical solutions and advantages of the present disclosure, the present disclosure will be described in further detail with reference to the specific embodiments and the accompanying drawings.

Next, the embodiments of the present disclosure will be described in detail, and examples of the embodiments are shown in the accompanying drawings. The same or similar reference numerals refer to the same or similar elements or elements having the same or similar functions throughout the specification. The embodiments described below with reference to the accompanying drawings are exemplary, only intend to explain the present disclosure, but should not be construed as limiting the present disclosure.

It will be understood by those skilled in the art that, unless specifically stated otherwise, the terms such as “a”, “an”, “the” and “this” used herein in singular form can include a plurality of objects. It should be further understood that, when it is described that an element is “connected” or “coupled” to another element, it can be directly connected or coupled to another element, or there may be an intermediate element between them. In addition, the terms such as “connection” or “coupling” used herein may include a wireless connection or a wireless coupling. The term “and/or” used herein includes one or more of the associated listed items, or a combination thereof or all of them.

It should be noted that, all the expressions “first” and “second” used in the embodiments of the present disclosure are intended to distinguish between two different entities or parameters which have the same name. Therefore, terms “first” and “second” are used for the sake of convenience of description, but should not be construed as limiting the embodiments of the present disclosure. It will not be further explained in the following embodiments.

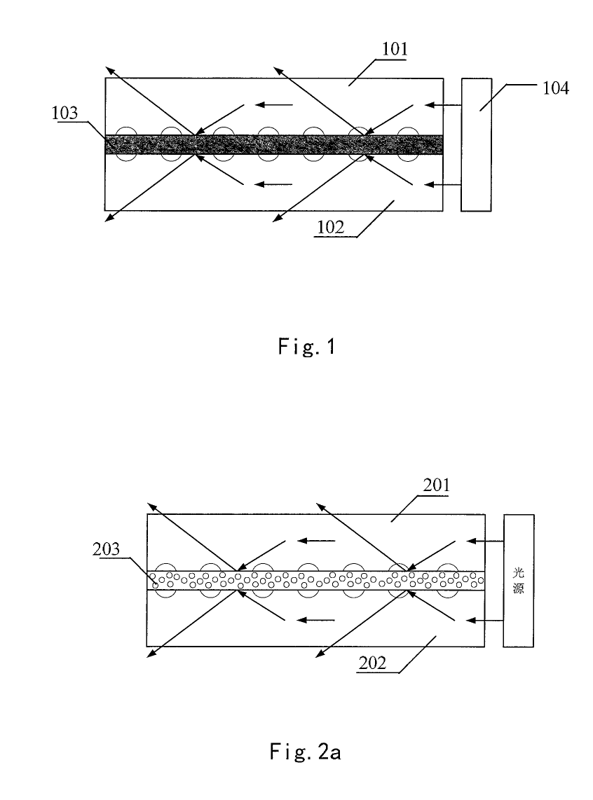

Referring to FIG. 1, there is provided a liquid crystal display device having a double-sided display function, including a double-sided light emitting backlight module. A light guide panel assembly in the backlight module includes a first light guide panel 101, a second light guide panel 102, and a reflective sheet 103 disposed between the first light guide panel 101 and the second light guide panel 102. A light source 104 in the backlight module is provided on a side of the first light guide panel 101, the second light guide panel 102 and the reflective sheet 103. The light source 104 may be a light emitting diode (LED). If the light emitting diode is energized, light rays are emitted into the backlight module from the side of the first light guide panel 101 and the second light guide panel 102, and then they are emitted out from a light exit surface of the first light guide panel 101 and a light exit surface of the second light guide panel 102 by reflection of the reflective sheet 103 having a reflection surface on both sides, so that the light guide panel assembly generates a double-sided light emitting effect. The double-sided light emitting backlight module can be used as a backlight source in an interior of a double-sided light transmitting billboard, or a double-sided display or a double-sided indicator and any other items.

However, the inventors of the present disclosure have found that the backlight module and the light guide panel assembly shown in FIG. 1 have at least the following problems during the actual production and usage:

In an assembly process of the backlight module, it is necessary to install two light guide panels, and install the reflective sheet sandwiched between the two light guide panels, therefore the assembly process is relatively complicated.

In a reliability experiment of the product, a vibration generated by the experiment may move the light guide panel relative to the reflective sheet, thereby scratching net dots of the light guide panel;

In a usage of the product, if it encounters a high temperature and high humidity of severe environment, the light guide panel may be bent, and thereby the reflective sheet is wrinkled, adversely affecting picture quality of the liquid crystal display.

In view of at least one aspect of the above-mentioned problems, the embodiments of the present disclosure provide a light guide panel assembly including two light guide panels and bubble glue disposed between opposing surfaces of the two light guide panels and configured to adhere the two light guide panels together. Herein, the bubble glue refers to glue containing bubbles. In an example, the bubble glue may be glue containing high density bubbles. A manufacturing method for this light guide panel assembly may include: producing bubble glue of semi-solid state by stirring glue in air; and applying the bubble glue between the opposing surfaces of the two light guide panels so as to adhere the two light guide panels together.

On one hand, the glue containing the bubbles is sandwiched between the two light guide panels so as to function as a reflective sheet, it reflects light rays which are incident on the light guide panels, and then the reflected light rays are emitted out from light exit surfaces of the light guide panels through the guiding of net dots of the light guide panels. On the other hand, since the two light guide panels are adhered together by the bubble glue, the light guide panel assembly composed of the two light guide panels and the bubble glue is substantially a component when assembling the backlight module, thereby facilitating the assembly. It is unnecessary to separately assemble three components including the two light guide panels and the reflective sheet, as shown in FIG. 1. Moreover, it is unnecessary to precisely ensure relative position relationship between the three components during the assembly process.

Further, in the integrated light guide panel assembly of the present disclosure by means of adhering together, the light guide panel will never be moved relative to the bubble glue in the reliability experiment of the product, thereby it can avoid scratching the net dots of the light guide panel.

In addition, in the usage of the product, if it encounters a high temperature and high humidity of severe environment, the reflective sheet will never be wrinkled in view of a certain flexibility of the bubble glue, even if the light guide panel is bent. Thus it avoids a poor picture quality of the liquid crystal display due to wrinkling phenomenon.

Accordingly, the present disclosure provides a number of specific embodiments, which will now be described in detail with reference to the accompanying drawings.

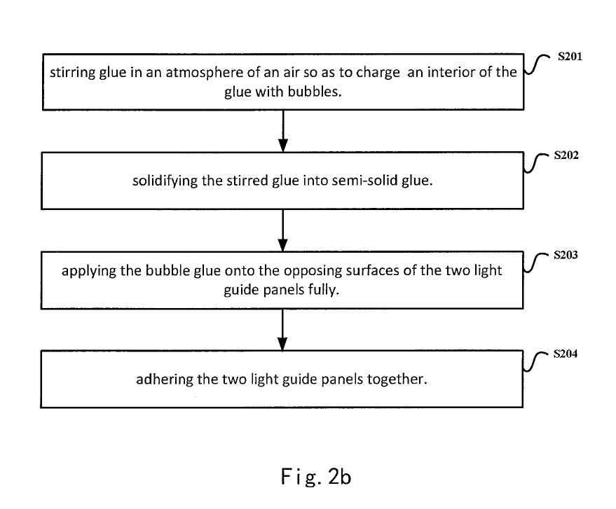

As shown in FIG. 2a, the light guide panel assembly according to an embodiment of the present disclosure includes: two light guide panels 201, 202; and bubble glue 203 disposed between opposing surfaces of the two light guide panels 201, 202 and configured to adhere the two light guide panels 201, 202 together.

In the two light guide panels, the first light guide panel 201 is parallel to the second light guide panel 202. A space between the opposing surfaces of the two light guide panels is fully charged or filled with the bubble glue 203, that is to say, the bubble glue 203 is fully charged between the opposing surfaces of the two light guide panels.

It is proved by the experiments that the bubble glue 203 can reflect the incident light rays due to the presence of bubbles. Therefore, as the optical path in FIG. 2a shows, the bubble glue 203 can reflect the light rays incident on the light guide panels, and then the reflected light rays are emitted out from the light exit surfaces of the light guide panels through the guiding of the net dots of the light guide panels.

In an example, the glue containing high density bubbles has a better reflection effect, and moreover, the glue having a low refractive index has a better reflection effect.

FIG. 2b is a flow chart of a manufacturing method for the light guide panel assembly shown in FIG. 2a. The method includes the steps of:

Step S201: stirring glue in an atmosphere of an air so as to charge an interior of the glue with bubbles.

In an example, the glue having a low refractive index may be used; the glue is stirred to charge the interior thereof with high density air bubbles.

Step S202: solidifying the stirred glue into semi-solid glue.

Step S203: applying the bubble glue onto the opposing surfaces of the two light guide panels fully.

For example, the semi-solid glue is fully applied to a surface to be adhered of the first light guide panel 201, and a surface to be adhered of the second light guide panel 202.

Step S204: adhering the two light guide panels together.

For example, the two light guide panels applied with the semi-solid glue are arranged in parallel to each other, and the bubble glue is fully charged in a space between the opposing surfaces of the two light guide panels. After the semi-solid glue is completely solidified, the integrated light guide panel assembly is achieved.

In the light guide panel assembly according to the embodiment of the present disclosure, since the two light guide panels are adhered together by the bubble glue, the light guide panel assembly composed of the two light guide panels and the bubble glue is substantially a component, when assembling the backlight module, thereby it saves the assembly for the multiple components, such as the multiple light guide panels, the reflective sheet and other components, shown in FIG. 1, and omits the complicated process for determining relative position relationship between various components, thereby simplifying the assembly process.

Since the two light guide panels are adhered together by the bubble glue, the light guide panel will never be moved relative to the bubble glue in the reliability experiment of the product, thereby it can avoid scratching the net dots of the light guide panel.

Since the bubble glue has a certain flexibility, in the usage of the product, the reflective sheet will never be wrinkled even if a high temperature and high humidity of severe environment is encountered and thus the light guide panel is bent. Thus it avoids a poor picture quality of the liquid crystal display due to wrinkle phenomenon.

In order to obtain more intensive emergent light rays, the light guide panel assembly according to another embodiment of the present disclosure is further provided with a reflective sheet on the basis of the above-described light guide panel assembly shown in FIG. 2a.

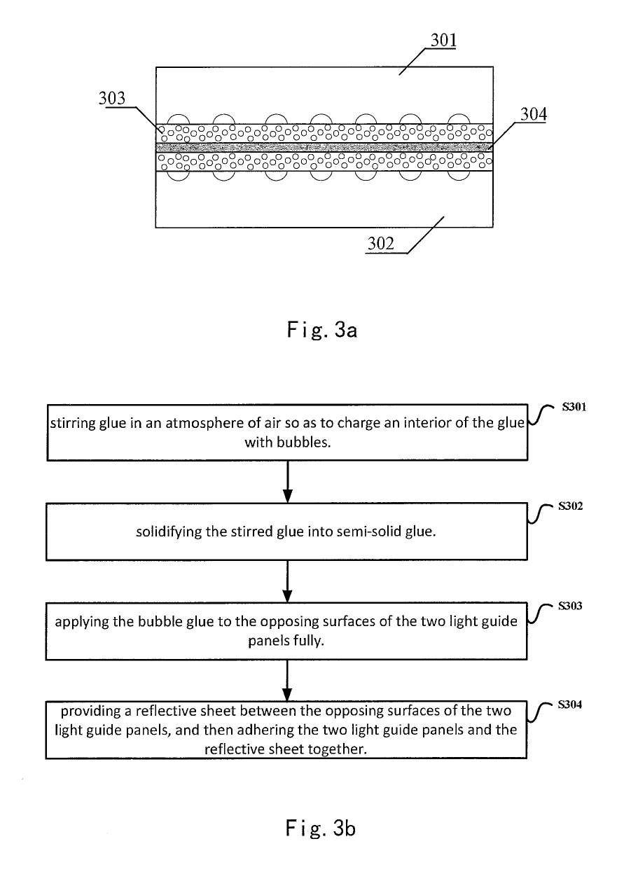

As shown in FIG. 3a, the light guide panel assembly includes: two light guide panels 301, 302; and bubble glue 303 disposed between opposing surfaces of the two light guide panels 301, 302 and configured to adhere the two light guide panels 301, 302 together. Additionally, the light guide panel assembly further includes a reflective sheet 304.

In the two light guide panels, the first light guide panel 301 is parallel to the second light guide panel 302. A space between the opposing surfaces of the two light guide panels is fully charged with the bubble glue 303. In an example, the glue containing high density bubbles has a better reflection effect, and moreover, the glue having a low refractive index has a better reflection effect.

The reflective sheet 304 is located between the opposing surfaces of the two light guide panels 301, 302, and is parallel to the opposing surfaces of the two light guide panels 301, 302 and is fixed by the bubble glue.

In an example, the reflective sheet 304 is arranged at a position from the opposing surfaces of the two light guide panels by a same distance, that is to say, the reflective sheet 304 is arranged at an intermediate position between the opposing surfaces of the two light guide panels 301, 302, and is parallel to the opposing surfaces of the two light guide panels 301, 302. Since the space between the opposing surfaces of the two light guide panels 301, 302 is fully charged with the bubble glue 303, the reflective sheet 304 between the opposing surfaces of the two light guide panels is located in the bubble glue 303 and is fixed by the solidified bubble glue.

Since the reflective sheet 304 is added to the light guide panel assembly shown in FIG. 3a, it can achieve a better light ray reflection effect so that the light rays emitted from the light exit surfaces of the light guide panels have higher light intensity.

Further, in the light guide panel assembly shown in FIG. 3a, since the bubble glue between the opposing surfaces of the two light guide panels further fixes an reflective sheet, the light guide panel assembly can achieve a better emergent light effect. In addition, the integrated light guide panel assembly formed by adhesive is substantially a component for the assembly of backlight module, thereby it saves the assembly for the multiple components, such as the multiple light guide panels, the reflective sheet and other components, shown in FIG. 1, and omits the complicated process for determining relative position relationship between various components, thereby simplifying the assembly process.

Since the two light guide panels and the reflective sheet are adhered together by the bubble glue, the light guide panel will never be moved relative to the bubble glue or the reflective sheet in the reliability experiment of the product, thereby it can avoid scratching the net dots of the light guide panel.

Since the bubble glue has a certain flexibility, in the usage of the product, the reflective sheet or the bubble glue will never be wrinkled even if a high temperature and high humidity of severe environment is encountered and thus the light guide panel is bent. In addition, the reflective sheet fixed by the bubble glue is designed to avoid the wrinkle phenomenon since the flexibility of the bubble glue buffers the pressure due to deformation stress of the light guide panel. Thus it avoids a poor picture quality of the liquid crystal display.

FIG. 3b is a flow chart of a manufacturing method for the light guide panel assembly shown in FIG. 3a. The method includes the steps of:

Step S301: stirring glue in an atmosphere of air so as to charge an interior of the glue with bubbles.

For example, the glue having a low refractive index may be used; and the glue is stirred to charge the interior thereof with high density air bubbles.

Step S302: solidifying the stirred glue into semi-solid glue.

Step S303: applying the bubble glue to the opposing surfaces of the two light guide panels fully.

In an example, the semi-solid glue is fully applied to a surface to be adhered of the first light guide panel 301, and a surface to be adhered of the second light guide panel 302.

Step S304: providing a reflective sheet between the opposing surfaces of the two light guide panels, and then adhering the two light guide panels and the reflective sheet together.

In particular, one surface of the reflective sheet is made close to a surface of the first light guide panel 301 applied with the bubble glue, and a surface of the second light guide panel 302 applied with the bubble glue is made close to the other surface of the reflective sheet, so that the reflective sheet is positioned between the opposing surfaces of the two light guide panels. Further, the two light guide panels and the reflective sheet are adhered together by the bubble glue, and the two light guide panels are made in parallel with each other and the reflective sheet is made in parallel with the opposing surfaces of the two light guide panels. After the semi-solid glue is completely solidified, the integrated light guide panel assembly is achieved.

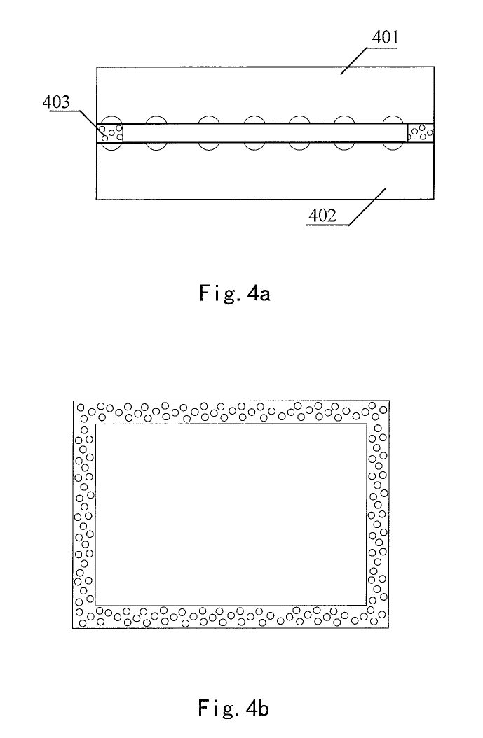

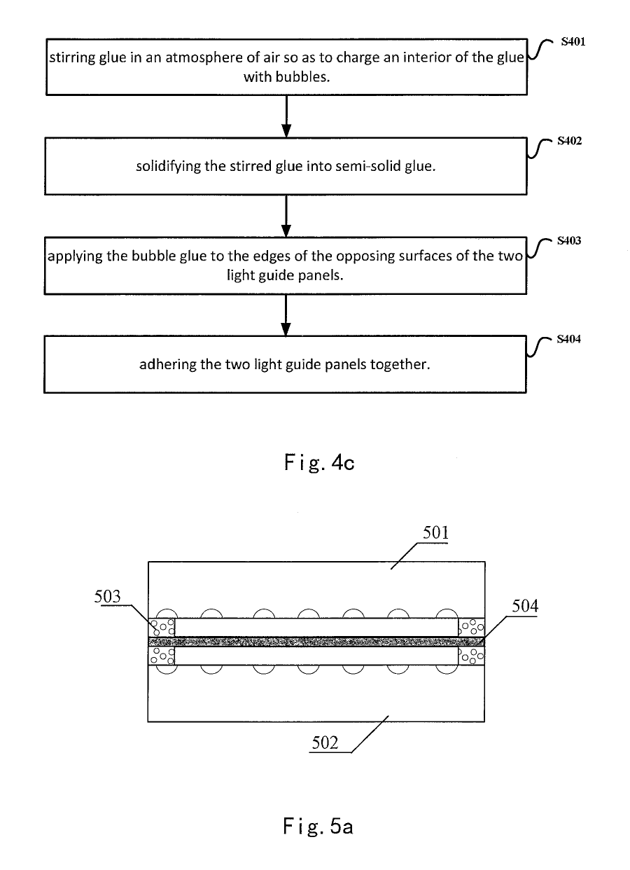

As shown in FIG. 4a, according to another embodiment of the present disclosure, there is provided a cost-reduced light guide panel assembly, including: two light guide panels 401, 402; and bubble glue 403 disposed between opposing surfaces of the two light guide panels 401, 402 and configured to adhere the two light guide panels 401, 402 together.

In the two light guide panels, the first light guide panel 401 is parallel to the second light guide panel 402. The adhesion is implemented by the bubble glue 403 at edges of the opposing surfaces of the two light guide panels 401, 402, that is to say, the bubble glue 403 is applied to the edges of the opposing surfaces of the two light guide panels 401, 402 so as to adhere the two light guide panels together.

In an example, the glue containing high density bubbles has a better reflection effect, and moreover, the glue having a low refractive index has a better reflection effect.

Between the opposing surfaces of the two light guide panels, a space which is not charged with the bubble glue 403 is charged with air. FIG. 4b shows a light guide panel which is applied with the bubble glue 403. It can be seen that, on a surface of the light guide panel to be applied with the bubble glue 403, only four edges (or a periphery border or frame) are applied with the bubble glue 403. Thus a middle part between the opposing surfaces of the two light guide panels is free of bubble glue, but charged with air. In this way, the glue material may be saved and the cost may be reduced.

Because of a relatively large difference between refractive indexes of the air and the light guide panel, the light rays will be reflected at the medium interface when the light rays enter into the air medium from the light guide panel, and then the reflected light rays are emitted out from the light exit surface of the light guide panel through the guiding of the net dots of the light guide panel.

Further, in the light guide panel assembly according to the embodiment shown in FIG. 4a, since the two light guide panels are adhered together by the bubble glue, the light guide panel assembly composed of the two light guide panels and the bubble glue is substantially a component for assembling the backlight module, thereby it saves the assembly for the multiple components, such as the multiple light guide panels, the reflective sheet and other components, and omits the complicated process for determining relative position relationship between various components, thereby simplifying the assembly process.

Since the two light guide panels are adhered together by the bubble glue, the light guide panel will never be moved relative to the bubble glue in the reliability experiment of the product, thereby it can avoid scratching the net dots of the light guide panel.

Due to a certain flexibility of the bubble glue or the air, in the usage of the product, the bubble glue or the air will never be wrinkled even if a high temperature and high humidity of severe environment is encountered and the light guide panel is bent. Thus it avoids a poor picture quality of the liquid crystal display due to wrinkle phenomenon.

FIG. 4c is a flow chart of a manufacturing method for the light guide panel assembly shown in FIG. 4a. The method includes the steps of:

Step S401: stirring glue in an atmosphere of air so as to charge an interior of the glue with bubbles.

In an example, the glue having a low refractive index may be used; the glue is stirred to charge the interior thereof with high density air bubbles.

Step S402: solidifying the stirred glue into semi-solid glue.

Step S403: applying the bubble glue to the edges of the opposing surfaces of the two light guide panels.

In this step, the bubble glue is applied to the edges of the opposing surfaces of the two light guide panels, as shown in FIG. 4b. Specifically, the semi-solid glue is applied to the edges of the opposing surface of the first light guide panel 401 (or the border or edge frame) and the edges of the opposing surface of the second light guide panel 402.

Step S404: adhering the two light guide panels together.

In particular, the two light guide panels applied with the semi-solid glue are arranged in parallel with each other, and then the bubble glue is charged into the space between the edges of the opposing surfaces of the two light guide panels. After the semi-solid glue is completely solidified, the integrated light guide panel assembly is achieved.

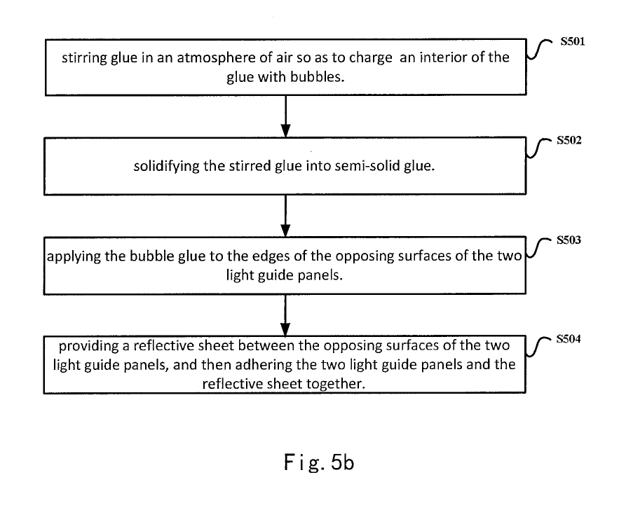

On the basis of the embodiment shown in FIG. 4a, a still another embodiment of the present disclosure provides a light guide panel assembly which is cost-reduced and can obtain more intensive emergent light rays. As shown in FIG. 5a, the light guide panel assembly includes: two light guide panels 501, 502; and bubble glue 503 disposed between opposing surfaces of the two light guide panels 501, 502 and configured to adhere the two light guide panels 501, 502 together. Additionally, the light guide panel assembly further includes a reflective sheet 504.

In the two light guide panels, the first light guide panel 501 is parallel to the second light guide panel 502. The adhesion is implemented by the bubble glue 503 at edges of the opposing surfaces of the two light guide panels, that is to say, the bubble glue 503 is applied to the edges of the opposing surfaces of the two light guide panels so as to adhere the two light guide panels together. Between the opposing surfaces of the two light guide panels, a space which is not charged with the bubble glue 503 is charged with air. In an example, the glue containing high density bubbles has a better reflection effect, and moreover, the glue having a low refractive index has a better reflection effect.

The reflective sheet 504 is located between the opposing surfaces of the two light guide panels, and is parallel to the opposing surfaces of the two light guide panels, and is fixed by the bubble glue 503.

In an example, the reflective sheet 504 is arranged at as position from the opposing surfaces of the two light guide panels by a same distance, that is to say, the reflective sheet 504 is arranged at an intermediate position between the opposing surfaces of the two light guide panels, and is parallel to the opposing surfaces of the two light guide panels. Since the edges (or the border) of the opposing surfaces of the two light guide panels are adhered to each other by the bobble glue 503, the edges of the reflective sheet 504 between the opposing surfaces of the two light guide panels are also adhered by the bobble glue 503 and are fixed by the solidified bubble glue.

Since only the edges are applied with the bubble glue, the glue material may be saved and the cost may be reduced. Moreover, since the reflective sheet 504 is added to the light guide panel assembly in the embodiment shown in FIG. 5a, it can achieve a better light ray reflection effect so that the light rays emitted from the light exit surfaces of the light guide panels have higher light intensity.

In addition, in the light guide panel assembly shown in FIG. 5a, the integrated light guide panel assembly formed by adhersion is substantially a component for the assembly of backlight module, thereby it saves the assembly for the multiple components, such as the multiple light guide panels, the reflective sheet and other components, shown in FIG. 1, and omits the complicated process for determining relative position relationship between various components, thereby simplifying the assembly process.

Since the two light guide panels and the reflective sheet are adhered together by the bubble glue, the light guide panel will never be moved relative to the bubble glue or the reflective sheet in the reliability experiment of the product, thereby it can avoid scratching the net dots of the light guide panel.

Since the bubble glue has a certain flexibility, in the usage of the product, the bubble glue will never be wrinkled even if a high temperature and high humidity of severe environment is encountered and the light guide panel is bent. In addition, the reflective sheet fixed by the bubble glue is free of the pressure due to deformation stress of the light guide panel so that the wrinkle phenomenon is avoided, since the air is provided to both sides of the reflective sheet. Thus it avoids a poor picture quality of the liquid crystal display.

FIG. 5b is a flow chart of a manufacturing method for the light guide panel assembly shown in FIG. 5a. The method includes the steps of:

Step S501: stirring glue in an atmosphere of air so as to charge an interior of the glue with bubbles.

In an example, the glue having a low refractive index may be used; and the glue is stirred to charge the interior thereof with high density air bubbles.

Step S502: solidifying the stirred glue into semi-solid glue.

Step S503: applying the bubble glue to the edges of the opposing surfaces of the two light guide panels.

In this step, the bubble glue is applied to the edges of the opposing surfaces of the two light guide panels, as shown in FIG. 5b. Specifically, the semi-solid glue is applied to the edges of the opposing surface of the first light guide panel 501 (or the border) and the edges of the opposing surface of the second light guide panel 502.

Step S504: providing a reflective sheet between the opposing surfaces of the two light guide panels, and then adhering the two light guide panels and the reflective sheet together.

In particular, one surface of the reflective sheet is made close to a surface of the first light guide panel 501 applied with the bubble glue, and a surface of the second light guide panel 502 applied with the bubble glue is made close to the other surface of the reflective sheet, so that the reflective sheet is positioned between the opposing surfaces of the two light guide panels. Further, the two light guide panels and the reflective sheet are adhered together by the bubble glue, and the two light guide panels are made in parallel with each other and the reflective sheet is made in parallel with the opposing surfaces of the two light guide panels. After the semi-solid glue is completely solidified, the integrated light guide panel assembly is achieved.

The backlight module according to the present disclosure may include the light guide panel assembly according to any one of the above embodiments.

In the technical solutions of the embodiments of the present disclosure, since the two light guide panels are adhered together by the bubble glue, the light guide panel assembly composed of the two light guide panels and the bubble glue is substantially a component for assembling the backlight module, thereby it saves the assembly for the multiple components, such as the multiple light guide panels, the reflective sheet and other components, and omits the complicated process for determining relative position relationship between various components, thereby simplifying the assembly process.

Moreover, since the two light guide panels are adhered together by the bubble glue, the light guide panel will never be moved relative to the bubble glue in the reliability experiment of the product, thereby it can avoid scratching the net dots of the light guide panel.

In addition, since the bubble glue has a certain flexibility, in the usage of the product, the bubble glue will never be wrinkled even if a high temperature and high humidity of severe environment is encountered and the light guide panel is bent. Thus it avoids a poor picture quality of the liquid crystal display due to wrinkle phenomenon.

It will be appreciated by those skilled in the art that the present disclosure includes one or more devices for implementing the operations described in the present disclosure. These devices may be specifically designed and manufactured for the desired objectives, or may also include known devices in a general purpose computer. These devices have computer programs stored therein, which are selectively activated or reconstructed. Such computer programs may be stored in a device-readable medium (e.g., a computer readable medium) or stored in any type of mediums suitable for storing electronic instructions and respectively coupled to a bus. The computer readable medium includes, but not limited to, any type of disks (including a floppy disk, a hard disk, an optical disk, a CD-ROM, and a magneto-optical disk), a ROM (Read-Only Memory), a RAM (Random Access Memory), a EPROM (Erasable Programmable Read-Only Memory), a EEPROM (Electrically Erasable Programmable Read-Only Memory), a flash memory, a magnetic card or a light card. That is, the readable medium includes any medium in which the information can be stored or transmitted by a device (e.g., a computer) in a readable form.

It will be appreciated by those skilled in the art that computer program instructions may be used to achieve each of or a combination of blocks of these structure charts and/or block diagrams and/or flow charts. It will be appreciated by those skilled in the art that these computer program instructions may be provided to a general purpose computer, a professional computer or any other processors for performing a programmable data processing method, so that the general purpose computer or other processors for performing a programmable data processing method can perform technical solutions specified in one or more blocks of the structure charts and/or block diagrams and/or flow charts of the present disclosure.

It will be appreciated by those skilled in the art that the steps, measures, and solutions of the various operations, methods, processes discussed in the present disclosure may be alternated, changed, combined or deleted. Further, the other steps, measures, and solutions of the various operations, methods, processes which are discussed in the present disclosure may also be alternated, changed, rearranged, decomposed, combined or deleted. Further, the steps, measures, and solutions of the various operations, methods, processes in the prior art which are same or similar to those of the present disclosure may also be alternated, changed, rearranged, decomposed, combined or deleted.

It will be appreciated by those skilled in the art that the discussion of any of the embodiments described above is merely exemplary and is not intended to imply that the scope of the present disclosure (including claims) is limited to these examples. In the context of the present disclosure, the technical features in the above or different embodiments may be combined, the steps may be implemented in any order, and there are many other variations of various aspects of the present disclosure as described above, which are not provided in detail for brevity. Accordingly, any omissions, modifications, equivalent substitutions, improvements, and the like, which do not depart from the spirit and principles of the present disclosure, fall within the scope of the present disclosure.

What is claimed is:

1. A light guide panel assembly, comprising:
two light guide panels; and
bubble glue disposed between opposing surfaces of the two light guide panels and configured to adhere the two light guide panels together.

2. The light guide panel assembly according to claim 1, wherein the bubble glue is fully charged between the opposing surfaces of the two light guide panels.

3. The light guide panel assembly according to claim 1, wherein the bubble glue is applied to edges of the opposing surfaces of the two light guide panels so as to adhere the two light guide panels together.

4. The light guide panel assembly according to claim 3, wherein air is charged in a space between the opposing surfaces of the two light guide panels other than the edges applied with the bubble glue.

5. The light guide panel assembly according to claim 1, further comprising a reflective sheet located between the opposing surfaces of the two light guide panels, the reflective sheet being parallel to the opposing surfaces of the two light guide panels and fixed by means of the bubble glue.

6. The light guide panel assembly according to claim 2, further comprising a reflective sheet located between the opposing surfaces of the two light guide panels, the reflective sheet being parallel to the opposing surfaces of the two light guide panels and fixed by means of the bubble glue.

7. The light guide panel assembly according to claim 3, further comprising a reflective sheet located between the opposing surfaces of the two light guide panels, the reflective sheet being parallel to the opposing surfaces of the two light guide panels and fixed by means of the bubble glue.

8. The light guide panel assembly according to claim 4, further comprising a reflective sheet located between the opposing surfaces of the two light guide panels, the reflective sheet being parallel to the opposing surfaces of the two light guide panels and fixed by means of the bubble glue.

9. The light guide panel assembly according to claim 5, wherein the bubble glue is glue containing high density bubbles.

10. The light guide panel assembly according to claim 5, wherein the bubble glue is glue with low refractive index.

11. The light guide panel assembly according to claim 6, wherein the bubble glue is glue containing high density bubbles.

12. The light guide panel assembly according to claim 6, wherein the bubble glue is glue with low refractive index.

13. The light guide panel assembly according to claim 7, wherein the bubble glue is glue containing high density bubbles.

14. The light guide panel assembly according to claim 7, wherein the bubble glue is glue with low refractive index.

15. A backlight module, comprising the light guide panel assembly according to claim 1.

16. A manufacturing method for a light guide panel assembly, comprising:
producing bubble glue of semi-solid state by stirring glue in an atmosphere of air; and
applying the bubble glue between opposing surfaces of two light guide panels so as to adhere the two light guide panels together.

17. The method according to claim 16, wherein the step of applying the bubble glue between the opposing surfaces of the two light guide panels comprises:
applying the bubble glue to edges of the opposing surfaces of the two light guide panels and charging air in a space between the opposing surfaces of the two light guide panels other than the edges applied with the bubble glue.

18. The method according to claim 16, wherein the step of applying the bubble glue between the opposing surfaces of the two light guide panels comprises:
charging the bubble glue between the opposing surfaces of the two light guide panels fully.

19. The method according to claim 16, after applying the bubble glue, further comprising:
providing a reflective sheet between the opposing surfaces of the two light guide panels.

20. The method according to claim 19, wherein the step of adhering the two light guide panels together comprises:
respectively adhering two sides of the reflective sheet with the bubble glue applied to the two light guide panels and making the reflective sheet parallel to the opposing surfaces of the two light guide panels.
